(19) United States
(12) Patent Application Publication
(10) Pub. No.: US 2005/0287986 A1
(43) Pub. Date: Dec. 29, 2005

(54) System and method for securing mobile equipment

(76) Inventors: Ajit V. Sathe, Chandler, AZ (US); Udbhava A. Shrivastava, Tempe, AZ (US); Jason Ku, San Mateo, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/882,007

(22) Filed: Jun. 29, 2004

(51) Int. Cl. H04Q 7/00

(52) U.S. Cl. 455/410

(57) ABSTRACT

Systems and methods for securing a mobile asset. In an implementation, a method includes receiving a user ID code associated with a user, receiving an asset ID code associated with a mobile asset, determining if the asset ID code is associated with the user ID code, and emitting an alarm indicator if the asset ID code is not associated with the user ID code.

### TECHNICAL FIELD OF THE INVENTION

The invention generally relates to mobile equipment, and more particularly to systems and methods that provide security for mobile equipment.

### BACKGROUND

Economic globalization and competitiveness are driving an increased need for corporate travel, multi-site corporations, and the need to locate sites flexibly to attract and retain employees. These trends have led to an increased reliance by companies on mobile employees who must be equipped with technologies that can provide them with fast and interactive mobile access to information. High-priced mobile assets such as laptop computers, notebook computers, personal digital assistants (PDAs), and mobile telephones are becoming vital for employees to stay connected and be productive.

The portability of mobile assets provides employees with the freedom to easily leave the confines of an office or other work area. Unfortunately, this portability also makes mobile assets an easy target for theft. An office or work area may contain anywhere from a few to hundreds of mobile assets. And because mobile assets are easily removed, a visitor to the office, an unscrupulous employee, a contractor, or any other person within the office or work area will have opportunities to misappropriate such assets. Companies that invest a large amount of capital in outfitting their employees with mobile equipment must then find methods to minimize the loss of mobile assets from the office or work area.

The primary method for mobile asset loss prevention is posting security guards at work area exits. The security guards can visually inspect employees, visitors, and others for mobile assets as they exit. If a person has a mobile asset, the security guard can verify that he or she is authorized to remove the mobile asset from the work area. The security guards can also perform searches on people as they exit to check for mobile assets that are not readily visible. These techniques of visual inspections and searches are ineffective at best, are very time-consuming, and realistically provide little in the way of loss prevention.

### BRIEF DESCRIPTION OF THE DRAWINGS

FIG. 1 illustrates a user identification card and a mobile asset identification device.

FIG. 2 illustrates key components of one implementation of a mobile asset security system.

FIG. 3A illustrates an implementation of a mobile asset security system using a remote authentication process.

FIG. 3B illustrates an implementation of a mobile asset security system using a local authentication process.

FIG. 4 is an implementation of a method for securing mobile assets using a remote authentication process.

FIG. 5 is an implementation of a method for restricting the movement of mobile assets within a work area.

FIG. 6 is an implementation of a method for restricting the movement of mobile assets out of a work area.

### DETAILED DESCRIPTION

Implementations of a system and method to secure mobile equipment are described herein. In the following description numerous specific details are set forth to provide a thorough understanding of the implementations. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

In one implementation, the system and method of the invention may be used to prevent the misappropriation of mobile equipment from buildings, work areas, or other secure areas by unauthorized persons. As used herein, the term “mobile asset” refers to any mobile equipment that can be carried away by a person, including but not limited to laptop computers, notebook computers, personal digital assistants (PDAs), pagers, mobile printers, mobile telephones, cameras, and video cameras. The term “secure area” refers to an area from which a mobile asset can be misappropriated, including but not limited to an office, a building, a campus, a warehouse, a laboratory, and other workplaces or work areas.

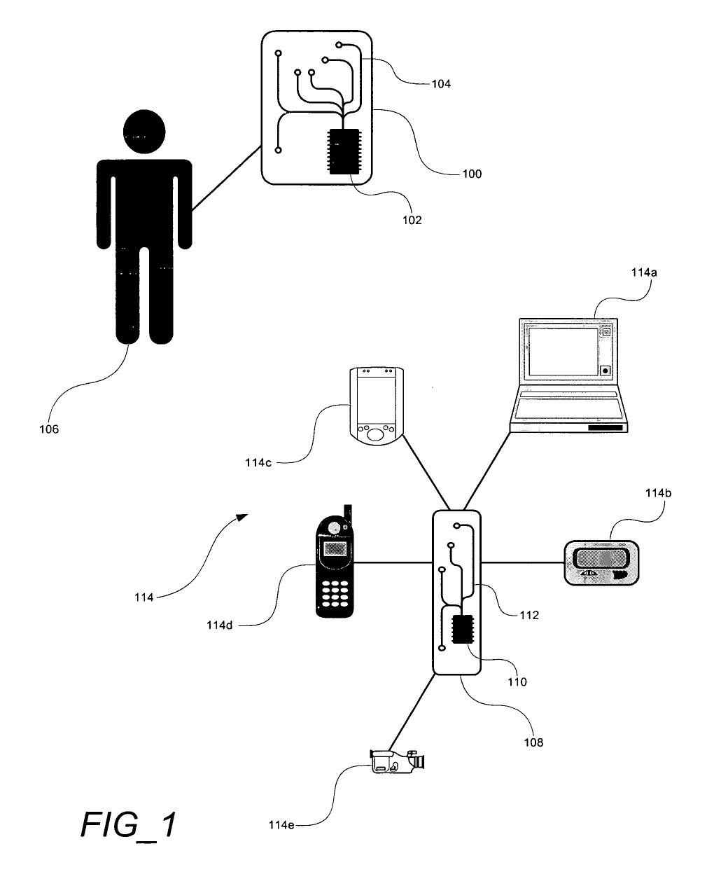

In accordance with an implementation of the invention, a mobile asset security system may be constructed that utilizes radio frequency identification (RFID) techniques. FIG. 1 illustrates two components of such a mobile asset security system. One implementation of a user identification card (user ID card) 100 is shown that includes an application specific integrated circuit (ASIC) 102 and an antenna 104. The user ID card 100 is associated with at least one user 106. An implementation of an asset identification device (asset ID device) 108 is also shown that includes its own ASIC 110 and antenna 112. The asset ID device 108 is associated with at least one mobile asset 114. As explained above, the mobile assets 114 may include, but are not limited to, a laptop or notebook computer 114a, a pager 114b, a PDA 114c, a mobile phone 114d, and a camera 114e.

The user ID card 100 is generally used to identify the user 106. In an implementation, the user ID card 100 can be approximately the size of a credit card or smaller. The user 106 may carry the user ID card 100 with them as they enter and exit a secure area. For example, the user 106 may carry the user ID card 100 in a wallet or purse, within a pocket of their clothing, or they may wear the user ID card 100 as an employee badge. The user 106 may also simply carry the user ID card 100 in their hand.

In implementations of the invention, the ASIC 102 and the antenna 104 are housed within the user ID card 100. Generally at least the ASIC 102 is not visible on the exterior of the user ID card 100. In an implementation, the ASIC 102 stores a user identification code (user ID code) that is associated with and uniquely identifies the user 106. The ASIC 102 has functionality to broadcast the user ID code by causing the antenna 104 to emit, reflect, or back-scatter electromagnetic waves. Systems that can receive and decipher the broadcast user ID code will be able to determine the identity of the user 106.

In an implementation, the user ID code can be established by the company or organization that either employs the user 106 or that has given the user 106 access to the secure area. Alternatively, the user ID code can be based on personal data of the user 106, such as a social security number, a driver's license number, a professional license number, a birth date, or other personal data belonging to the user 106. In an implementation of the invention, the association between the user 106 and the user ID code can be stored in an electronic storage device, such as a database, a hard disk drive, a flash memory, or other storage devices.

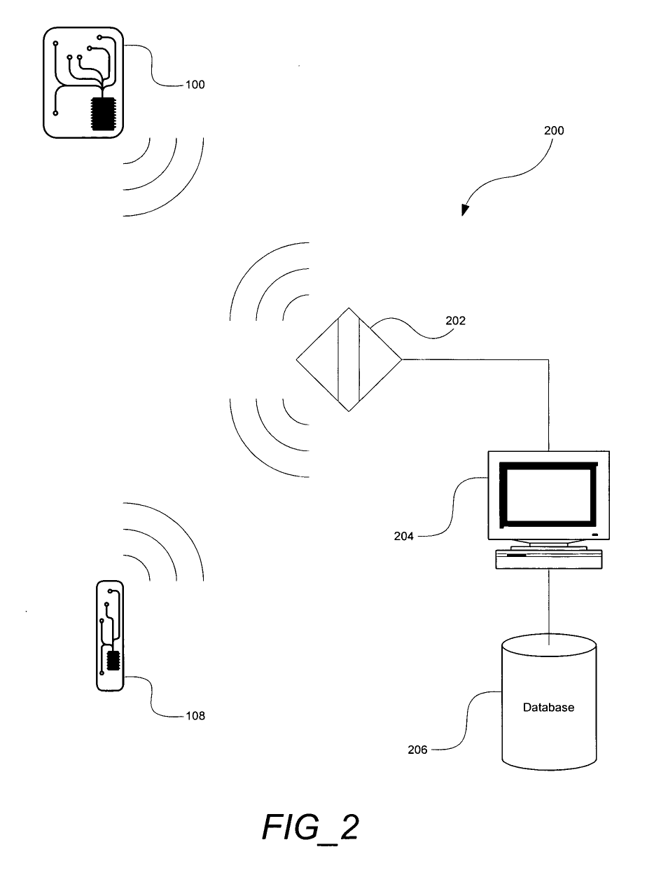

In an implementation of the invention, the ASIC 102 within the user ID card 100 is passive and must be energized to function. As described with reference to FIG. 2 below, the ASIC 102 may be energized using electromagnetic energy that is captured by the antenna 104. In another implementation, the ASIC 102 is active and receives power from a battery (not shown) or other power source housed within the user ID card 100.

The asset ID device 108 is primarily used to identify a mobile asset 114. In an implementation of the invention, the asset ID device 108 is constructed in a similar fashion to the user ID card 100. The asset ID device 108 may be smaller in size than the user ID card 100 to facilitate the mounting of the asset ID device 108 on or within the mobile asset 114.

In one implementation, the asset ID device 108 may be an external device capable of being mounted on the exterior of the mobile asset 114. In other implementations, the asset ID device 108 may be an internal device capable of either being mounted within a mobile asset 114 or being included as part of the interior hardware of the mobile asset 114. For instance, in one implementation, the ASIC 110 and the antenna 112 of the asset ID device 108 may be built directly upon a motherboard of the laptop or notebook computer 114a. In other implementations, the ASIC 110 and the antenna 112 may be built upon any printed circuit board (PCB) found within the mobile asset 114. As one of skill in the art will recognize, an external asset ID device 108 will generally require a housing to hold the ASIC 110 and the antenna 112. Thus, an external asset ID device 108 may be built as a card. An internal asset ID device, however, may not need a housing for the ASIC 110 and the antenna 112 since these components may be built as part of the internal hardware of the mobile asset 114.

An internal asset ID device 108 is generally less susceptible to tampering than an external asset ID device 108. While an external asset ID device 108 may be visible and potentially removed by a person, an internal asset ID device 108 is less likely to be detected. Even if a person is aware that an internal asset ID device 108 is present within the mobile asset 114, if the asset ID device 108 is built upon a PCB of the mobile asset 114, the device 108 will be difficult to remove or disable.

In an implementation of the invention, the ASIC 110 stores an asset identification code (asset ID code) that is associated with the mobile asset 114. In one implementation, the asset ID code uniquely identifies the mobile asset 114. In another implementation, the asset ID code uniquely identifies one or more users 106 that are authorized to remove the mobile asset 114 from the secure area (referred to herein as “authorized users”). In further implementations, the asset ID code serves to both uniquely identify the mobile asset 114 and identify one or more authorized users 106. The ASIC 110 has the functionality to broadcast the asset ID code by causing the antenna 112 to emit, reflect, or back-scatter electromagnetic waves. Systems that can receive and decipher the broadcast asset ID code will be able to determine the identity of the mobile asset 114 and/or an authorized user 106.

In implementations of the invention, the asset ID code can be established by the company or organization that owns or is responsible for the mobile asset 114 or it can be based on the mobile asset 114 itself. For instance, if the asset ID code serves to uniquely identify the mobile asset 114, the asset ID code can be based on data such as a serial number or inventory control number for the mobile asset 114. Alternatively, if the asset ID code serves to identify an authorized user 106, the asset ID code can be based on the identity of the authorized user 106 or it can be based on or derived from a user ID code associated with the authorized user 106. In an implementation of the invention, for example, the asset ID code may be derived from the user ID code based on an algorithm designed to convert the user ID code into a corresponding asset ID code. As explained below, this algorithm can later be used to determine if a received asset ID code is associated with a received user ID code. In an implementation of the invention, the association between the mobile asset 114 and the asset ID code can be stored in an electronic storage device, such as a database, a hard disk drive, a flash memory, or other storage devices.

In an implementation, the ASIC 110 within the asset ID device 108 is passive and must be energized to function. As described with reference to FIG. 2 below, the ASIC 110 may be energized using electromagnetic energy that is captured by the antenna 112. In another implementation, the ASIC 110 is active and receives power from a battery or power source found within the asset ID device 108 or within the mobile asset 114.

FIG. 2 illustrates a mobile asset security system 200 constructed in accordance with an implementation of the invention. In addition to the user ID card 100 and the asset ID device 108, the mobile asset security system 200 may include an interrogator 202, a central processing unit (CPU) 204, and a database 206. In an implementation, the interrogator 202 may include an internal micro-controller, a transmitter, a receiver, and an antenna. The interrogator 202 can emit electromagnetic waves to establish a zone of surveillance that is generally located at a point of exit for the secure area. In an implementation, the emitted electromagnetic waves are capable of energizing a passive user ID card 100 and a passive asset ID device 108. The interrogator 202 is also capable of capturing user ID codes broadcast from user ID cards 100 and asset ID codes broadcast from asset ID devices 108.

In an implementation of the invention, the interrogator 202 is coupled to the CPU 204. The interrogator 202 may transmit captured user ID codes and asset ID codes to the CPU 204 for processing. The CPU 204 includes functionality to determine if the user 106 associated with the captured user ID code is authorized to remove the mobile asset 114 associated with the captured asset ID code. In one implementation, the CPU 204 may identify the user 106 based on the user ID code and the mobile asset 114 based on the asset ID code. With that information, the CPU may then determine if the identified user 106 is authorized to remove the identified mobile asset 114 from the secure area. In another implementation, the CPU 204 may simply determine if the asset ID code is associated with the user ID code. If the CPU 204 determines that the asset ID code is indeed associated with the user ID code, it may conclude that the user 106 is authorized to remove the mobile asset 114 from the secure area.

In an implementation of the invention, the CPU 204 is coupled to the database 206 and the database 206 may store information used to identify users 106 based on user ID codes and mobile assets 114 based on asset ID codes. For instance, in one implementation the database 206 may include a table that associates users 106 with user ID codes and mobile assets 114 with asset ID codes. The database 206 may also store associations between users 106 and mobile assets 114 that identify which mobile assets 114 a particular user 106 is authorized to remove from the secure area. In one implementation the database 206 may include a table that stores such associations between mobile assets 114 and their corresponding authorized users 106. In another implementation, the database 206 may store associations between user ID codes and asset ID codes without necessarily identifying the specific users 106 or the specific mobile assets 114. These associations may identify which user ID codes are authorized to exit with a given asset ID code. In such an implementation, the database 206 may include a table that associates each asset ID code with the user ID code of its authorized user 106. In an implementation, the database 206 is located local to the CPU 204 and is coupled to the CPU 204 through a direct connection. In another implementation, the database 206 is located remote from the CPU 204 and is coupled to the CPU 204 through a network connection, such as a local area network (LAN) connection or a wide area network (WAN) connection. In yet another implementation, the database 206 is located within the CPU 204.

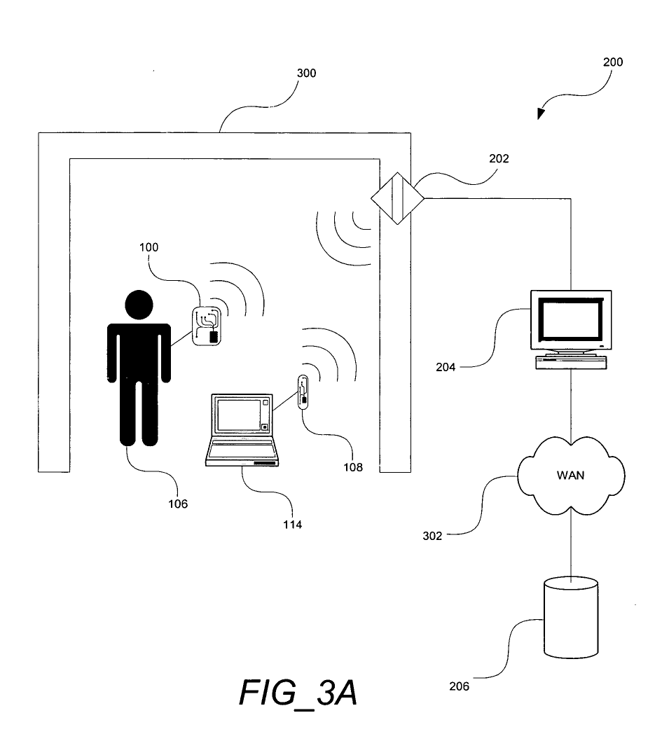

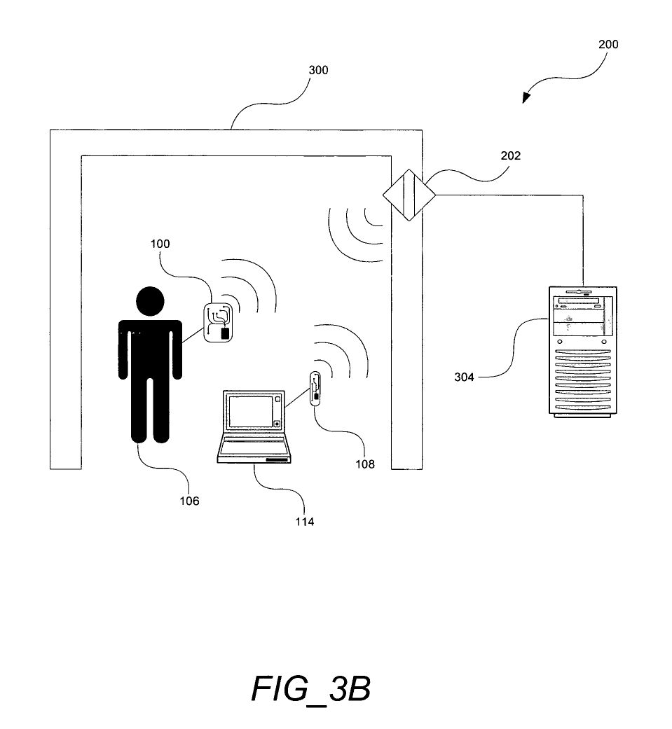

FIG. 3A illustrates a real world implementation of the mobile asset security system 200. As shown, the interrogator 202 may be mounted on a gate 300 used as an exit for the secure area. The interrogator 202 may emit electromagnetic waves to establish a zone of surveillance around the gate 300. In one implementation, as a user 106 comes within proximity of the gate 300 with a mobile asset 114, the user ID card 100 and the asset ID device 108 are energized by the electromagnetic waves. Once energized, the user ID card 100 broadcasts a user ID code and the asset ID device 108 broadcasts an asset ID code. The user ID code is associated with the user 106 passing through the gate 300 and the asset ID code is associated with the mobile asset 114 that is in the possession of the user 106. In an implementation, the interrogator 202 may capture the broadcast user ID code and asset ID code. The interrogator 202 may also be capable of transmitting the user ID code and the asset ID code to the CPU 204.

As shown in FIG. 3A, in one implementation the CPU 204 may be coupled to the database 206 though a network connection, such as a WAN 302. The use of the WAN 302 allows the database 206 to be stored at a location remote from the gate 300. This is advantageous because a company will generally set up multiple exits from one or more secure areas, and multiple exits require multiple gates 300 and multiple CPUs 204. Allowing the database 206 to reside at a remote location and be accessible over a WAN 302 allows each of the multiple CPUs 204 to access the same information stored on the database 206. A separate database 206 is therefore not needed at each gate 300. Those of skill in the art will appreciate the advantages a single, network-based database 206 offers, such as providing consistent and up-to-date information to each of the multiple CPUs 204.

In another implementation, both the user ID card 100 and the asset ID device 108 are self-powered and do not require electromagnetic wave energy. The user ID card 100 and the asset ID device 108 simply broadcast the user ID code and the asset ID code when approaching or passing through the gate 300. In one implementation, one or both of the user ID card 100 and the asset ID device 108 may continuously broadcast the user ID code and the asset ID code. In another implementation, one or both of the user ID card 100 and the asset ID device 108 may selectively broadcast the user ID code and the asset ID code when the codes are needed. For instance, the user ID card 100 and the asset ID device 108 may sense that they are within proximity of the gate 300 based on signals received from the interrogator 202. The user ID card 100 and the asset ID device 108 may then begin broadcasting the user ID code and the asset ID code. In another implementation, the user 106 may activate the user ID card 100 and/or the asset ID device 108 when approaching the gate 300. This activation may occur, for example, by pressing a button on the user ID card 100 and/or on the asset ID device 108.

FIG. 3B illustrates another implementation of the mobile asset security system 200. In this implementation, the interrogator 202 is mounted on the gate 300 and is coupled directly to a local computer 304. There is no access to the remote database 206 in this implementation. Here the local computer 304 is used to process a captured user ID code and asset ID code to determine if a user 106 is authorized to remove a mobile asset 114 from the secure area.

Similar to FIG. 3A above, the interrogator 202 shown in FIG. 3B can emit electromagnetic waves to establish a zone of surveillance at the gate 300. These electromagnetic waves can energize the user ID card 100 and the asset ID device 108 when the user 106 comes within proximity of the gate 300 with the mobile asset 114. When energized, the user ID card 100 broadcasts the user ID code and the asset ID device 108 broadcasts the asset ID code. The interrogator 202 may capture the user ID code and asset ID code and transmit them to the local computer 302. In another implementation, the user ID card 100 and the asset ID device 108 are self-powered and do not require electromagnetic waves for energy.

In an implementation of the invention, the local computer 302 can receive and process the user ID code and the asset ID code. For instance, in one implementation, the local computer 302 can include a database that contains information identifying the user 106 based on the user ID code and the mobile asset 114 based on the asset ID code. The database of the local computer 302 can also contain associations between users 106 and mobile assets 114, or between user ID codes and asset ID codes, to determine which users 106 are authorized to remove which mobile assets 114 from the secure area.

In another implementation, the local computer may contain an algorithm that is used to determine if a captured asset ID code is associated with a captured used ID code. For example, in an implementation of the invention, the asset ID code for a mobile asset 114 may be directly derived from the user ID code of an authorized user 106 using a predetermined algorithm. When the interrogator 202 captures and transmits a user ID code and an asset ID code to the local computer 302, the local computer 302 may use this predetermined algorithm to determine whether that the captured asset ID code is derived from the captured user ID code. If the local computer 302 uses the algorithm and finds that the captured asset ID code is indeed derived from the captured user ID code, the local computer 302 may conclude that the user 106 is an authorized user. Otherwise, if the local computer 302 uses the algorithm and finds that the captured asset ID code is not derived from the captured user ID code, the local computer 302 may conclude that the user 106 is not authorized to remove the mobile asset 114 from the secure area. The use of a predetermined algorithm eliminates the need for the database 206 described in FIGS. 2 and 3A.

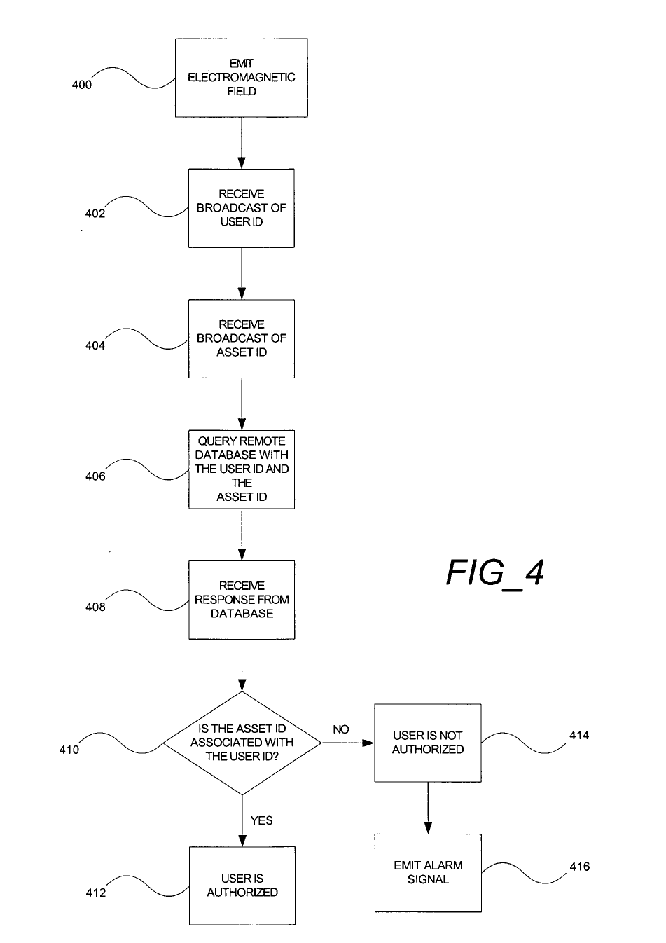

FIG. 4 is a method for using a mobile asset security system in accordance with an implementation of the invention. The security system creates a zone of surveillance by emitting an electromagnetic field (400). When a user and a mobile asset are within proximity of the zone of surveillance, the security system captures a broadcast user ID code (402) and a broadcast asset ID code (404). The security system then queries a database with the captured user ID code and the captured asset ID code (406). The query is to determine if the user associated with the captured user ID code is authorized to leave the secure area with the mobile asset associated with the captured asset ID code.

The security system then receives a response to the query from the database (408). The security system parses the response to determine whether the captured asset ID code is indeed associated with the captured user ID code (410). If the captured asset ID code is associated with the captured user ID code, the system concludes that the user is authorized to remove the mobile asset from the secure area (412). The user is generally allowed to pass out of the zone of surveillance with no further action required. A green light or a pleasant sound may be emitted to verify to the user and to any security personnel that the user is authorized. If, however, the captured asset ID code is not associated with the captured user ID code, the system concludes that the user is not authorized to remove the mobile asset from the secure area (414) and emits an alarm signal (416). The alarm signal is designed to alert the user and the security personnel that the system believes that the user is not authorized to remove the mobile asset from the secure area. In implementations of the invention, the alarm signal may be an audible signal that can take many forms that include, but are not limited to, an alarm sound, a siren, a spoken warning, a buzzing sound, or any other unpleasant sound. In other implementations, the alarm signal may be a visual signal that can also take many forms that include, but are not limited to, one or more flashing lights, a strobe light, a red light, or a message that appears on a display screen for security personnel to see. In further implementations, both an audible and a visual alarm signal can be emitted.

When the alarm signal is emitted, a security guard posted at the zone of surveillance can intervene to determine if the security system is in error or if the user is indeed attempting to misappropriate a mobile asset. If no security guard is present, the user may be denied exit out of the secure area. For example, a door or gate that would normally allow the user to exit the secure area may close or may become locked.

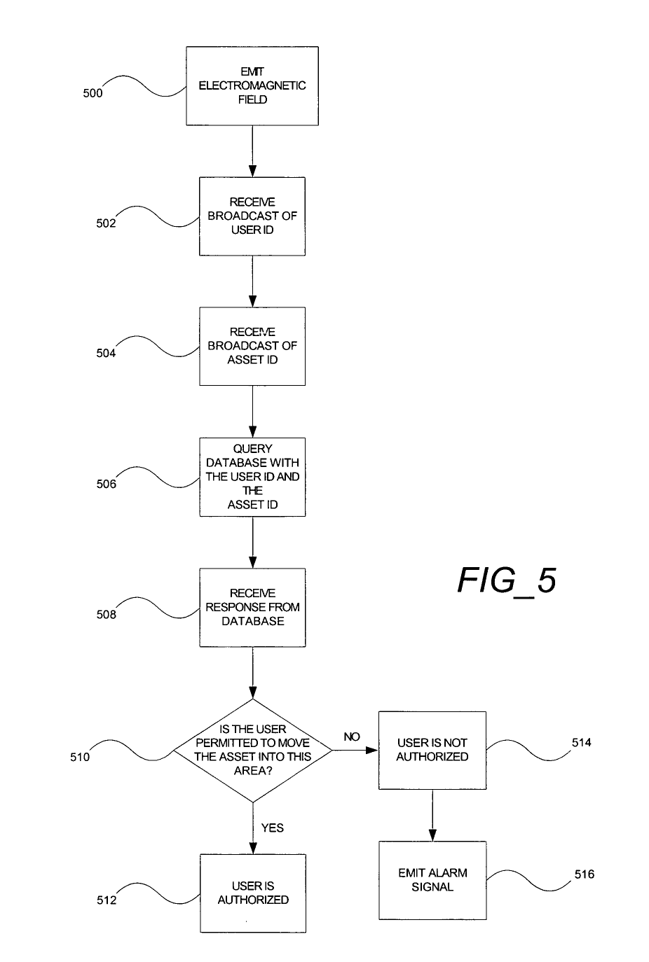

FIG. 5 is a method for using the mobile asset security system of the invention to restrict the movement of a mobile asset within a secure area. The security system creates a zone of surveillance between a first region of the secure area and a second region of the secure area by emitting an electromagnetic field (500). When a user and a mobile asset are within proximity of the zone of surveillance, the security system captures a broadcast user ID code (502) and a broadcast asset ID code (504). The security system then queries a database with the captured user ID code and the captured asset ID code (506). Here, the query is to determine if the user associated with the captured user ID code is authorized to move the mobile asset associated with the captured asset ID code out of the first region and into the second region of the secure area.

The security system then receives a response to the query from the database (508). The security system parses the response to determine whether the user is indeed authorized to move the mobile asset from the first region into the second region. If the response supports allowing the user to move the mobile asset into the second region, the system concludes that the user is authorized (512). The user is generally allowed to pass into the second region with no further action required. Again, a green light or a pleasant sound may be emitted to verify to the user and to any security personnel that the user is authorized. If, however, the response does not support allowing the user to move the mobile asset into the second region, the system determines that the user is not authorized (514) and the system generally emits an audible or visual alarm signal (516). As described above, a security guard posted at the zone of surveillance can intervene to determine if the security system is in error or if the user is attempting to perform an unauthorized move of the mobile asset. If no security guard is present, the user may be denied entrance into the second region. For example, a door or gate into the second region may close or become locked.

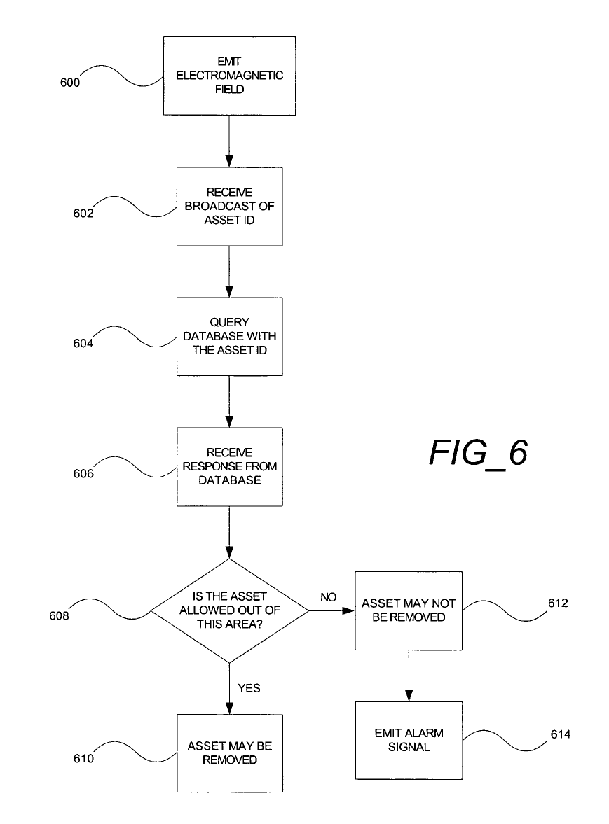

FIG. 6 is a method for using the mobile asset security system of the invention to restrict a mobile asset from being moved out of a secure area, regardless of which user is attempting to move the mobile asset. Once again, the security system begins by creating a zone of surveillance by emitting an electromagnetic field (600). When a user brings a mobile asset within proximity of the zone of surveillance, the security system captures a broadcast asset ID code (602). The security system then queries a database with the captured asset ID code (604). The query is to determine if the mobile asset associated with the captured asset ID code has been restricted and is not allowed out of the secure area.

The security system then receives a response to the query from the database (606). The security system parses the response to determine whether the mobile asset associated with the captured asset ID code is allowed out of the secure area (608). If the mobile asset associated with the captured asset ID code is unrestricted, the system concludes that the mobile asset can be removed from the secure area (610). The user is generally allowed to pass out of the zone of surveillance with no further action required. Again, a green light or a pleasant sound may be emitted to verify to the user and to any security personnel that the mobile asset is unrestricted. If, however, the mobile asset associated with the captured asset ID code is restricted, the system concludes that the mobile asset may not be removed from the secure area (612) and the system generally emits an audible or visual alarm signal (614). Further action is generally required in this situation, such as a security guard posted at the zone of surveillance intervening to confiscate the mobile asset from the user attempting to remove the restricted mobile asset from the secure area. If no security guard is present, the user may be denied exit out of the secure area with the mobile asset. Again, a door or gate that would normally allow the user to exit the secure area may close or may become locked.

As will be recognized by those of ordinary skill in the art, in other implementations of the invention, systems other than the specific proximity card system described above can be used. For instance, implementations of the invention can utilize magnetic stripe systems, Weigand systems, smart card systems, biometric systems, barcode systems, Bluetooth systems, IEEE 802.11 systems, infrared systems, and other proximity, wireless, or magnetic systems.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific implementations disclosed in the specification and the claims. Rather, the scope of the invention is to be determined entirely by the following claims, which are to be construed in accordance with established doctrines of claim interpretation.

1. A system to secure a mobile asset comprising:
a user identification card to broadcast a user ID code;
an asset identification device to broadcast an asset ID code;
an interrogator to capture the user ID code and the asset ID code;
a central processing unit coupled to the interrogator to determine if the asset ID code is associated with the user ID code; and
a database coupled to the central processing unit to store information that indicates whether the asset ID code is associated with the user ID code.

2. The system of claim 1, wherein if the central processing unit determines that the asset ID code is associated with the user ID code, the system allows a user associated with the user ID code to remove a mobile asset associated with the asset ID code from a secure area.

3. The system of claim 2, wherein if the central processing unit determines that the asset ID code is not associated with the user ID code, the system does not allow the user associated with the user ID code to remove the mobile asset associated with the asset ID code from the secure area.

4. The system of claim 1, wherein the user identification card is constructed as an employee badge that can be worn by the user.

5. The system of claim 1, wherein the user identification card comprises a first ASIC and a first antenna.

6. The system of claim 5, wherein the first ASIC stores the user ID code and can broadcast the user ID code using the first antenna.

7. The system of claim 5, wherein the asset identification device comprises a second ASIC and a second antenna.

8. The system of claim 7, wherein the second ASIC stores the asset ID code and can broadcast the asset ID code using the second antenna.

9. The system of claim 7, wherein the asset identification device is mounted on the exterior of a mobile asset.

10. The system of claim 7, wherein the asset identification device is mounted on the interior of a mobile asset.

11. The system of claim 2, wherein the mobile asset is a laptop computer, a notebook computer, a personal digital assistant, a mobile phone, a pager, a camera, or a video camera.

12. The system of claim 1, wherein the interrogator can emit electromagnetic waves to establish a zone of surveillance.

13. The system of claim 7, wherein:
the interrogator can emit electromagnetic waves to establish a zone of surveillance,
the first antenna can capture the electromagnetic waves to energize the user identification card, and
the second antenna can capture the electromagnetic waves to energize the asset identification device.

14. The system of claim 1, wherein the interrogator can transmit the user ID code and the asset ID code to the central processing unit.

15. The system of claim 14, wherein the central processing unit can receive the user ID code and the asset ID code from the interrogator and can query the database with the user ID code and the asset ID code to determine if the asset ID code is associated with the user ID code.

16. The system of claim 3, wherein if the central processing unit determines that the asset ID code is not associated with the user ID code, the system can emit an alarm signal.

17. The system of claim 1, wherein the information that indicates whether the asset ID code is associated with the user ID code comprises information that indicates whether a user associated with the user ID code is authorized to remove a mobile asset associated with the asset ID code from a secure area.

18. The system of claim 1, wherein the asset ID code is associated with the user ID code when a user associated with the user ID code is authorized to remove a mobile asset associated with the asset ID code from a secure area.

19. The system of claim 3, wherein the secure area comprises an office, a building, a campus, a warehouse, a laboratory, or a work area.

20. The system of claim 17, wherein the secure area comprises an office, a building, a campus, a warehouse, a laboratory, or a work area.

21. The system of claim 18, wherein the secure area comprises an office, a building, a campus, a warehouse, a laboratory, or a work area.

22. A system to secure a mobile asset comprising:
a user identification card to broadcast a user ID code;
an asset identification device to broadcast an asset ID code;
an interrogator to capture the user ID code and the asset ID code; and
a central processing unit coupled to the interrogator to determine if the asset ID code is associated with the user ID code.

23. The system of claim 22, wherein the asset ID code is associated with the user ID code if the asset ID code is derived from the user ID code based on an algorithm.

24. The system of claim 23, wherein the interrogator can transmit the user ID code and the asset ID code to the central processing unit.

25. The system of claim 24, wherein the central processing unit has functionality to:
receive the user ID code and the asset ID code from the interrogator,
store the algorithm, and
determine if the asset ID code is derived from the user ID code based on the algorithm.

26. The system of claim 25, wherein if the central processing unit determines that the asset ID code is derived from the user ID code based on the algorithm, the system allows a user associated with the user ID code to remove a mobile asset associated with the asset ID code from a secure area.

27. The system of claim 25, wherein if the central processing unit determines that the asset ID code is not derived from the user ID code based on the algorithm, the system does not allow a user associated with the user ID code to remove a mobile asset associated with the asset ID code from a secure area.

28. A method to secure a mobile asset comprising:
receiving a user ID code;
receiving an asset ID code;
determining if the asset ID code is associated with the user ID code; and
emitting an alarm indicator if the asset ID code is not associated with the user ID code.

29. The method of claim 28, further comprising:
emitting electromagnetic waves to establish a zone of surveillance.

30. The method of claim 28, wherein determining if the asset ID code is associated with the user ID code comprises:
querying a database with the asset ID code and the user ID code;
receiving a response from the database indicating if the asset ID code is associated with the user ID code.

31. The method of claim 28, wherein determining if the asset ID code is associated with the user ID code comprises determining if the asset ID code is derived from the user ID code.

32. The method of claim 28, wherein emitting an alarm indicator comprises emitting an audible alarm indicator.

33. The method of claim 28, wherein emitting an alarm indicator comprises emitting a visible alarm indicator.

34. A system to secure a mobile asset comprising:
an interrogator to capture a broadcast user ID code and a broadcast asset ID code;
a central processing unit coupled to the interrogator to determine if the captured asset ID code is associated with the captured user ID code; and
a database coupled to the central processing unit to store information that indicates whether the asset ID code is associated with the user ID code.

35. The system of claim 34, wherein if the central processing unit determines that the asset ID code is associated with the user ID code, the system allows a user associated with the user ID code to remove a mobile asset associated with the asset ID code from a secure area.

36. The system of claim 35, wherein if the central processing unit determines that the asset ID code is not associated with the user ID code, the system does not allow the user associated with the user ID code to remove the mobile asset associated with the asset ID code from the secure area.

37. The system of claim 34, wherein the interrogator can emit electromagnetic waves to establish a zone of surveillance.

38. The system of claim 34, wherein the central processing unit can query the database with the user ID code and the asset ID code to determine if the asset ID code is associated with the user ID code.

39. The system of claim 36, wherein if the central processing unit determines that the asset ID code is not associated with the user ID code, the system can emit an alarm indicator.

40. The system of claim 34, wherein the information that indicates whether the asset ID code is associated with the user ID code comprises information that indicates whether a user associated with the user ID code is authorized to remove a mobile asset associated with the asset ID code from a secure area.

41. The system of claim 34, wherein the asset ID code is associated with the user ID code when a user associated with the user ID code is authorized to remove a mobile asset associated with the asset ID code from a secure area.

42. The system of claim 36, wherein the secure area comprises an office, a building, a campus, a warehouse, a laboratory, or a work area.

43. A system to restrict movement of a mobile asset comprising:
an interrogator to establish a zone of surveillance using electromagnetic waves and to capture a broadcast user ID code and a broadcast asset ID code;
a central processing unit coupled to the interrogator to determine if the captured asset ID code is associated with the captured user ID code; and
a database coupled to the central processing unit to store information that indicates whether the asset ID code is associated with the user ID code.

44. The system of claim 43, further comprising a user identification card to broadcast the user ID code and an asset identification device to broadcast the asset ID code.

45. The system of claim 43, wherein if the central processing unit determines that the asset ID code is associated with the user ID code, the system allows a user associated with the user ID code to move a mobile asset associated with the asset ID code from a first region of a secure area to a second region of a secure area.

46. The system of claim 45, wherein if the central processing unit determines that the asset ID code is not associated with the user ID code, the system does not allow the user associated with the user ID code to move the mobile asset associated with the asset ID code from the first region of the secure area to the second region of the secure area.

47. A system to secure a mobile asset comprising:
an interrogator to establish a zone of surveillance using electromagnetic waves and to capture a broadcast asset ID code associated with a mobile asset;
a central processing unit coupled to the interrogator to determine if the mobile asset associated with the captured asset ID code is not permitted outside of a secure area; and
a database coupled to the central processing unit to store information that indicates whether the mobile asset associated with the asset ID code is permitted outside of the secure area.

48. The system of claim 47, further comprising an asset identification device to broadcast the asset ID code.

49. The system of claim 47, wherein if the central processing unit determines that the mobile asset associated with the asset ID code is not permitted outside of the secure area, the system does not allow a user to move the mobile asset out of the secure area.

50. The system of claim 49, wherein if the central processing unit determines that the mobile asset associated with the asset ID code is permitted outside of the secure area, the system allows a user to move the mobile asset out of the secure area.

51. A system to secure a mobile asset comprising:
a user identification card to broadcast a user ID code; and
an asset identification device to broadcast an asset ID code, wherein the asset ID code is associated with the user ID code.

52. The system of claim 51, wherein the user identification card is constructed as an employee badge that can be worn by the user.

53. The system of claim 51, wherein the user identification card comprises a first ASIC and a first antenna.

54. The system of claim 53, wherein the first ASIC stores the user ID code and can broadcast the user ID code using the first antenna.

55. The system of claim 53, wherein the asset identification device comprises a second ASIC and a second antenna.

56. The system of claim 55, wherein the second ASIC stores the asset ID code and can broadcast the asset ID code using the second antenna.

57. The system of claim 55, wherein the asset identification device is mounted on the exterior of a mobile asset.

58. The system of claim 55, wherein the asset identification device is mounted on the interior of a mobile asset.

59. The system of claim 58, wherein the asset identification device is built on a printed circuit board within the mobile asset.

60. The system of claim 55, wherein the first antenna can capture electromagnetic waves to energize the user identification card and the second antenna can capture electromagnetic waves to energize the asset identification device.
